(19) United States
(12) Patent Application Publication
(10) Pub. No.: US 2025/0111119 A1
(43) Pub. Date: Apr. 3, 2025

(54) LOW-LATENCY ALIGNED MODULES FOR DATA STREAMS

(71) Applicants: XILINX, INC., San jose, CA (US); ATI Technologies ULC, Thornhill (CA)

(72) Inventors: David P. SCHULTZ, Seattle, WA (US); Yanfeng WANG, Ontario (CA); Millind MITTAL, Saratoga, CA (US)

(21) Appl. No.: 18/375,342

(22) Filed: Sep. 29, 2023

(51) Int. Cl. G06F 30/347; G06F 115/02

(52) U.S. Cl. CPC G06F 30/347; G06F 2115/02

(57) ABSTRACT

A multi-chiplet system includes a first chiplet comprising a first transceiver and a first chiplet-to-chiplet (C2C) interface module, and a second chiplet comprising programmable logic circuitry and a second C2C interface module. The first transceiver is configured to generate a clock, which is transmitted from the first C2C interface module to the second C2C interface module, through a clock transmission wire, for data transfer between the first chiplet and the second chiplet.

### TECHNICAL FIELD

Examples of the present disclosure generally relate to integrated circuit (IC) design, and in particular to a multi-chiplet IC that enables low-latency aligned data streams through chiplet-to-chiplet (C2C) interfaces.

### BACKGROUND

System-on-a-chip (SoC) design using modular chiplets has gained popularity over traditional monolithic chips as chiplets offer advantages such as flexible design and reduced cost. Allowing semiconductor chiplets to be interconnected on a single package through C2C (or die-to-die (D2D)) interfaces enables an ecosystem supporting dis-aggregated die architectures having different protocols and functionalities. The Universal Chiplet Interconnect express (UCIe) standard is an important step forward for heterogeneous integration of semiconductor chiplets.

While the standard of connectivity provided by UCIe is useful, it comes with overhead (e.g., increased latency), and does not accommodate specific requirements of certain components such as high-speed transceivers. For example, in a programmable logic device construction of a modular design, high-speed transceivers are implemented on a transceiver chiplet, while the transceiver protocol(s) are implemented in programmable logic on a separate chiplet. This presents challenges for transceiver protocol implementation if a standard UCIe interface as currently defined is used. For example, implementation of a transceiver protocol often requires the clock signals (or clocks) that are generated within the high-speed transceiver circuitry to be used within the transceiver protocol circuitry. The current UCIe standard has not defined a mechanism for transmission of such clocks. Another limiting aspect of the current UCIe standard is the lack of flexibility in module alignment. The standard describes Multi-Module Physical (PHY) Logic (MMPL) which is fixed in two or four module implementations. In programmable logic applications, as a transceiver protocol may be defined with one, two, four, or more linked lanes as part of a single channel, flexibility in module alignment is desired. In addition, as the specific usages may be unknown at the time of device construction, the current UCIe standard does not offer flexibility in combining the adjacent modules.

Thus, solutions for preserving transceiver clock characteristics, reducing latency, and improving flexibility in multi-module alignment for inter-chiplet data flow are desired.

### SUMMARY

Systems, methods, and apparatuses are described that enable low-latency aligned data streams between chiplets through C2C interfaces.

According to one aspect, a system includes a first chiplet having a first transceiver and a first C2C interface module, and a second chiplet having a second C2C interface module. The first transceiver is configured to generate a clock, which is transmitted from the first C2C interface module to the second C2C interface module through a clock transmission wire for data transfer between the first chiplet and the second chiplet.

According to another aspect, a method, performed by a system having a first chiplet and a second chiplet, includes generating a clock by a first transceiver on the first chiplet, transmitting the clock from a first C2C interface module on the first chiplet to a second C2C interface module on the second chiplet, and using the clock by the second chiplet for data transfer between the first chiplet and the second chiplet.

According to yet another aspect, a chiplet includes a transceiver and a C2C interface module, wherein the transceiver is configured to transmit a transceiver-generated clock to another chiplet through the C2C interface module for data transfer.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A illustrates a block diagram of a multi-chiplet IC including two chiplets coupled to each other through UCIe interface modules, according to an example.

FIG. 1B illustrates a block diagram of a multi-chiplet IC including two chiplets coupled to each other through UCIe interface modules, according to an example.

FIG. 2A illustrates a flowchart illustrating a method for data transfer between two chiplets in transmit (TX) mode, according to an example.

FIG. 2B illustrates a flowchart illustrating a method for data transfer between two chiplets in receive (RX) mode, according to an example.

FIG. 3A illustrates is a block diagram showing portions of a first chiplet and portions of a second chiplet coupled to each other through UCIe interface modules in TX mode, according to an example.

FIG. 3B illustrates a block diagram showing portions of the first chiplet and portions of the second chiplet coupled to each other through the UCIe interface modules in RX mode, according to an example.

FIG. 4A illustrates a block diagram of four UCIe interface modules providing data through four independent GT links or channels, according to an example.

FIG. 4B illustrates a block diagram of four UCIe interface modules combined to provide data through two independent GT direct links or channels, according to an example.

FIG. 4C illustrates a block diagram of four UCIe interface modules combined to provide data through a single independent GT direct link or channel, according to an example.

FIG. 5A illustrates a block diagram of four UCIe interface modules providing data through four independent Ethernet links or channels, according to an example.

FIG. 5B illustrates a block diagram of four UCIe interface modules combined to provide data through two independent Ethernet links or channels, according to an example.

FIG. 5C illustrates a block diagram of four UCIe interface modules combined to provide data through a single independent Ethernet link or channel, according to an example.

FIG. 6 illustrates a block diagram of a chiplet IC architecture, according to an example.

FIG. 7 illustrates a block diagram of a multi-chiplet IC including alignment circuitry, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive explanation of the description or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

A monolithically integrated programmable logic device typically includes programmable logic and high-speed transceivers (HSTs) integrated on a same semiconductor die, where data and clocks on the HSTs can be transmitted to the programmable logic at high speed and with low latency. For example, data transfer between an HST's external pin and the programmable logic on the same semiconductor die can experience latency as low as 10 nanoseconds. However, when transceivers and programmable logic are separately formed on different semiconductor dies or chiplets, the transceivers communicate with the programmable logic through C2C (e.g., UCIe) interface modules implemented on the chiplets.

Under the UCIe interface specification as currently defined, instead of transferring the transceiver clock signals (or clocks) (e.g., transmit (TX) and receive (RX) clocks) directly from the transceiver chiplet to the programmable logic chiplet, the transceiver clock(s) would have to be converted to clock(s) of the UCIe interface modules (e.g., UCIe PHY clock(s)) before being transferred to the programmable logic (and vice versa).

For certain transceiver protocols (e.g., synchronous Ethernet, video broadcast, inline “bump-in-the-wire” applications), maintaining the transceiver-generated clocks and the characteristics thereof is important to ensure the transceiver(s) and the protocol(s) implemented in the programmable logic operate in a synchronized manner. Embodiments of the present disclosure describe systems, methods, and apparatuses for low-latency aligned data steams between chiplets through UCIe interface modules, while also supporting certain specialized protocols (e.g., high-speed transceiver protocols).

In relation to and/or in addition to the current UCIe interface specification, a multi-chiplet IC in the present disclosure provides a low-latency synchronous clock forwarded UCIe interface module that enables a transceiver-generated clock to be transmitted from a transceiver chiplet to another chiplet (e.g., an anchor chiplet having a transceiver protocol implemented in programmable logic thereon), such that the characteristics (e.g., long-term jitter, etc.) of the transceiver-generated clock are maintained throughout the system to improve synchronicity between the two chiplets. The multi-chiplet IC also provides a datapath through the UCIe interface module, where the datapath bypasses a protocol layer and at least a portion of a D2D adapter layer of the UCIe interface module to reduce latency in inter-chiplet data transfer. The multi-chiplet IC includes alignment circuitry on the transceiver chiplet between the transceivers and the UCIe interface modules to support flexible multi-module alignment. The multi-chiplet IC also includes alignment circuitry on the anchor chiplet between UCIe interface modules and protocols implemented in the programmable logic to meet lane alignment requirements of certain specialized transceiver protocols.

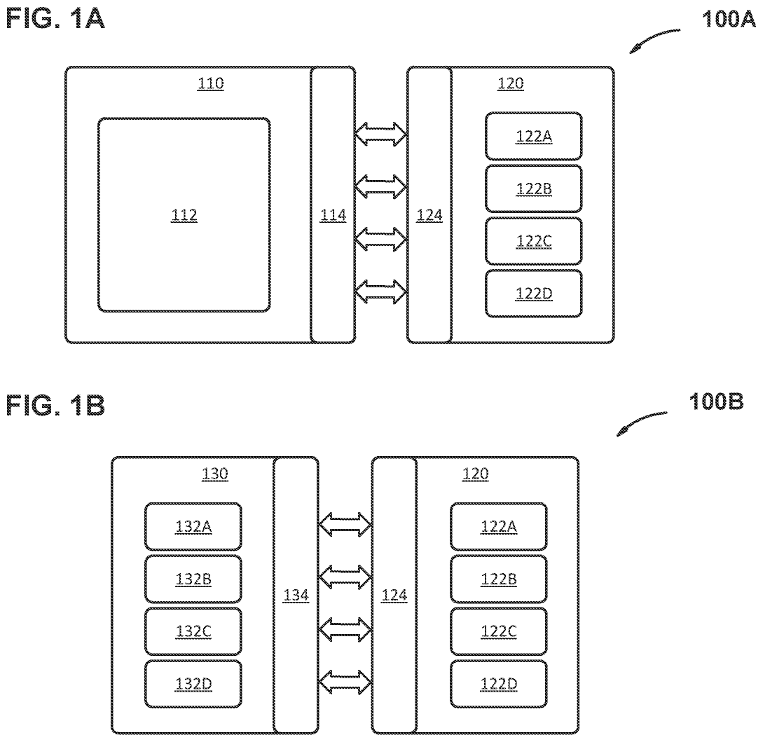

FIG. 1A illustrates a block diagram of a multi-chiplet IC 100A including chiplet ICs (chiplets) 110 and 120 coupled to each other through UCIe interface modules, according to an example. As illustrated in FIG. 1A, the chiplet 110 includes programmable logic 112 and a UCIe interface module 114. By way of example only, the programmable logic 112 may at least partially be provided by one or more of field programmable gate arrays (FPGAs). The programmable logic 112 may accommodate one or more look up tables (LUTs) and other logic in configurable logic blocks (CLBs). The programmable logic 112 may be programmed to perform a wide variety of functions corresponding to the particular end-user applications. The UCIe interface module 114 may include a UCIe protocol layer, a UCIe D2D adapter layer and a UCIe PHY layer, not explicitly shown in FIG. 1A. The UCIe interface module 114 is implemented on the chiplet 110 to transmit data to and receive data from another chiplet, such as the chiplet 120. In another example, the chiplet 110 may include Application Specific Integrated Circuits (ASICs) coupled to the UCIe interface module 114 to transmit data to and receive data from another chiplet, such as the chiplet 120.

In the present example, the chiplet 110 is an anchor chiplet. The chiplet 110 may include circuitry comprising one or more data processing blocks, such as a processing system or subsystem (PS), a memory system (e.g., including a memory controller), and the like, to handle data provided by or to the chiplet 120.

As illustrated in FIG. 1A, the chiplet 120 includes gigabit transceivers (GTs) 122A, 122B, 122C, and 122D (collectively referred to as “the GTs 122”), and a UCIe interface module 124. In another example, each of the GTs 122 may be coupled to a separate UCIe interface module 124. The chiplet 120 may also include other intellectual property (IP) blocks such as a Peripheral Component Interconnect Express (PCIe)/Cache Coherent Interconnect for Accelerators (CCIX) media access control (MAC) core associated with a Processor Subsystem (PS) and direct memory access (DMA) engines and controllers, all of which are omitted from FIG. 1A for clarity.

In the present example, the chiplet 120 is a GT Medium Access Control (MAC) PCIe Chiplet (GMPC), which is a multi-function high-speed I/O chiplet. The chiplet 120 may include adaptive and embedded computing group (AECG) modules that are highly flexible and programmable to handle a wide spectrum of applications. The chiplet 120 may handle GT direct applications with protocols implemented in the programmable logic 112 with different configurations. Examples of the protocols that the chiplet 120 can handle may include, but are not limited to, Ethernet, synchronous Ethernet (SyncE), PCIe-Test and Measurement (PCIe-T&M), Joint Electron Device Engineering Council (JEDEC) Serial Interface for Data Converters (JESD), Optical Interconnect Forum-Common Electrical Interface (OIF-CEI), Interlaken (ILKN), Common Public Radio Interface (CPRI), and Advanced Microcontroller Bus Architecture (AMBA) Advanced eXtensible Interface 4 (AXI-4).

The GTs 122 may be individually programmed to conform to different standards or protocols. In addition, the TX and RX paths of each GT 122 may be separately programmed such that the TX path of the transceiver can support one standard or protocol while the RX path of the same transceiver can support a different standard or protocol. Further, two or more GTs 122 may be bonded together to provide faster transmission speed and/or greater bandwidth. Each of the GTs 122 may perform a serial-to-parallel conversion on received data and perform a parallel-to-serial conversion on transmit data.

In some embodiments, each of the GTs 122 may achieve a bandwidth of 1.25 gigabits per second (Gbps) to 112 Gbps per data lane, and an aggregated bandwidth of up to 1.6 terabits per second (Tbps) on a single data link. In some embodiments, the chiplet 120 may also include PCIe Gen6 AXI-S and DMA AXI-MM interfaces (not explicitly shown in FIG. 1A) with many possible bifurcation configurations (e.g., x2, x4, x8, x16, or any combination thereof). In some embodiments, the chiplet 120 may support Ethernet MAC AXI-S with a variety of possible port configurations (e.g., 10G, 25G, 50G, 100G, 200G, 400G, 800G, 1.6T, etc.).

The chiplet 120 may be coupled to the chiplet 110 via the UCIe interface modules 114 and 124, and physical or hardwired connections. The UCIe interface modules 114 and 124 may be programmable (for example, via a programming software model employing a programming interface for the end user). In some embodiments, the UCIe interface modules may comprise digital and analog components that enable communication between two or more chiplets.

According to embodiments of the present disclosure, the clock characteristics from one or more of the GTs 122 are transferred to the programmable logic 112 through the UCIe interface modules 124 and 114 substantially without alteration. In other words, the chiplets 110 and 120 are able to maintain the characteristics (e.g., frequency, long-term jitter, etc.) of the transceiver-generated clock signal(s) throughout the system. The multi-chiplet IC 100A shown in FIG. 1A is substantially synchronous between the clock domain on the GT side and the clock domain on the programmable logic side across the UCIe interface modules, thereby eliminating a need for First In First Out (FIFO) buffers, which would otherwise add latency and create differences between the clock domains.

It should be understood that, although only one chiplet 120 is coupled to the chiplet 110 (e.g., an anchor chiplet) in the multi-chiplet IC 100A, the chiplet 110 can support multiple chiplets having a homogeneous arrangement of a single type of chiplets 120 or having a heterogeneous arrangement of more than one type of chiplets 120.

FIG. 1B illustrates a block diagram of a multi-chiplet IC 100B including chiplet ICs (chiplets) 120 and 130 coupled to each other through UCIe interface modules, according to an example. In the present example, the chiplet 120 may correspond to the chiplet 120 in FIG. 1A. The chiplet 130 includes GTs 132A, 132B, 132C, and 132D (collectively referred to as “the GTs 132”), and a UCIe interface module 134. In an example, the chiplet 130 may perform substantially similar functions and support substantially similar protocols as the chiplet 120. In another example, the chiplet 130 may perform different functions and support different protocols from the chiplet 120. The GTs 122 in the chiplet 120 and the GTs 132 in the chiplet 130 may communicate with each other through the UCIe interface modules 124 and 134.

According to embodiments of the present disclosure, the clock characteristics from one or more of the GTs 122 are maintained as they are transmitted to the GTs 132 through the UCIe interface modules 124 and 134 without alteration (e.g., without being converted to UCIe PHY clocks), and vice versa. For example, the GTs 122 on the chiplet 120 may each provide a serial data stream and a clock signal to one or more of the GTs 132 on the chiplet 130 through the UCIe interface modules 124 and 134. The one or more GTs 132 on the chiplet 130 may receive the clock signals from the GTs 122 without losing the clock characteristics. In other words, the multi-chiplet IC 100B shown in FIG. 1B is synchronous between the GTs 122 and the GTs 132, thereby eliminating a need for FIFO buffers, which would otherwise add latency and create differences between the clock domains.

It should be noted that, the scope of various aspects of the present disclosure should not be limited by characteristics (e.g., types of chiplets, transceiver protocols, bandwidths, clock frequencies, etc.) of the multi-chiplet ICs shown in FIGS. 1A and 1B.

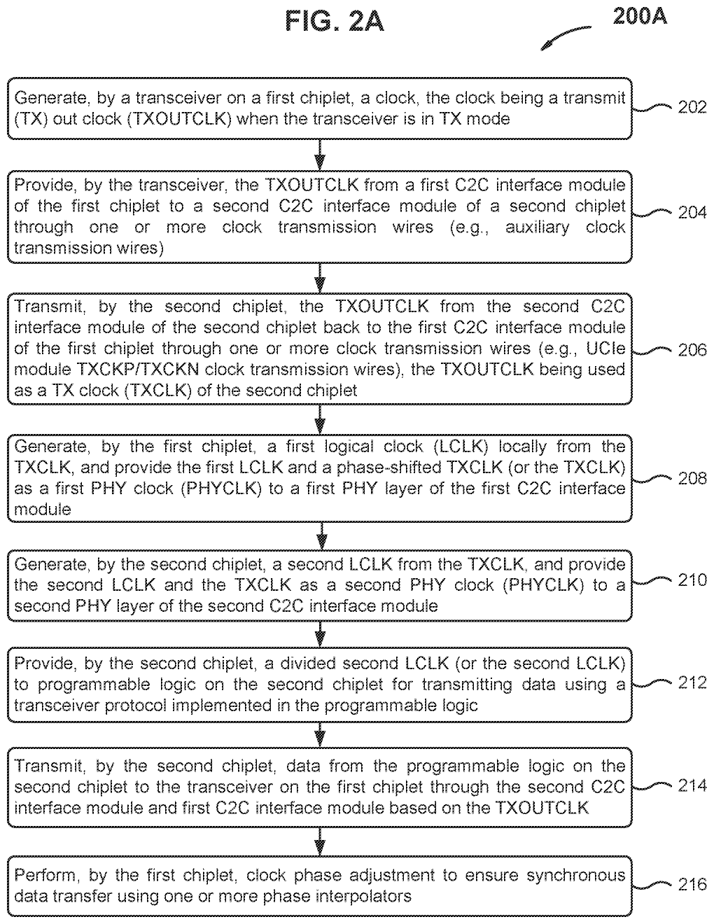

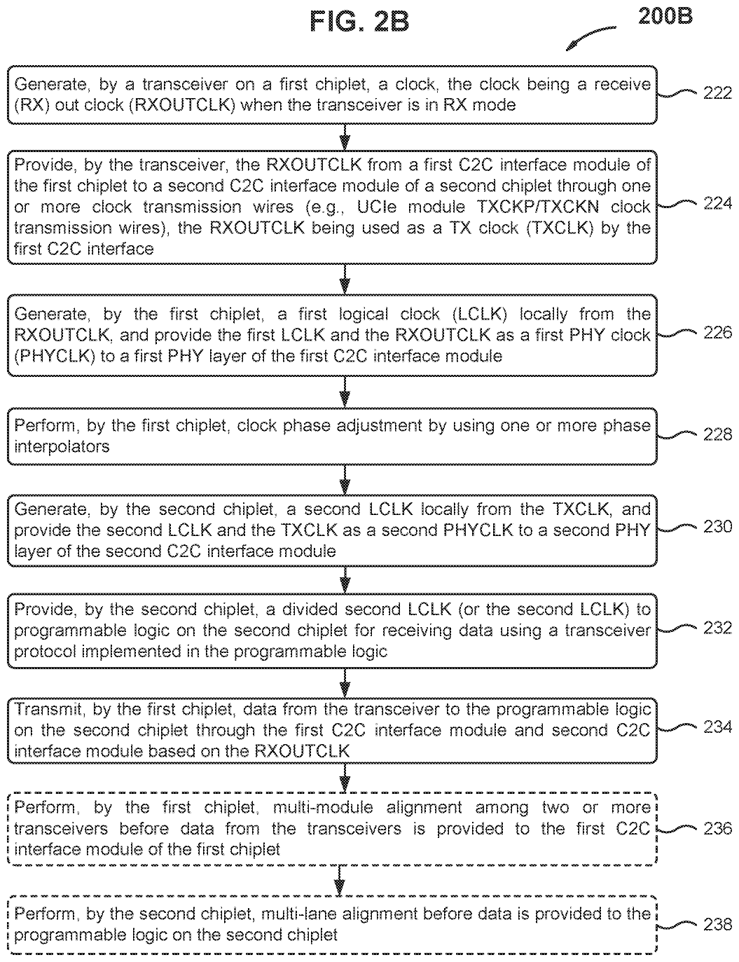

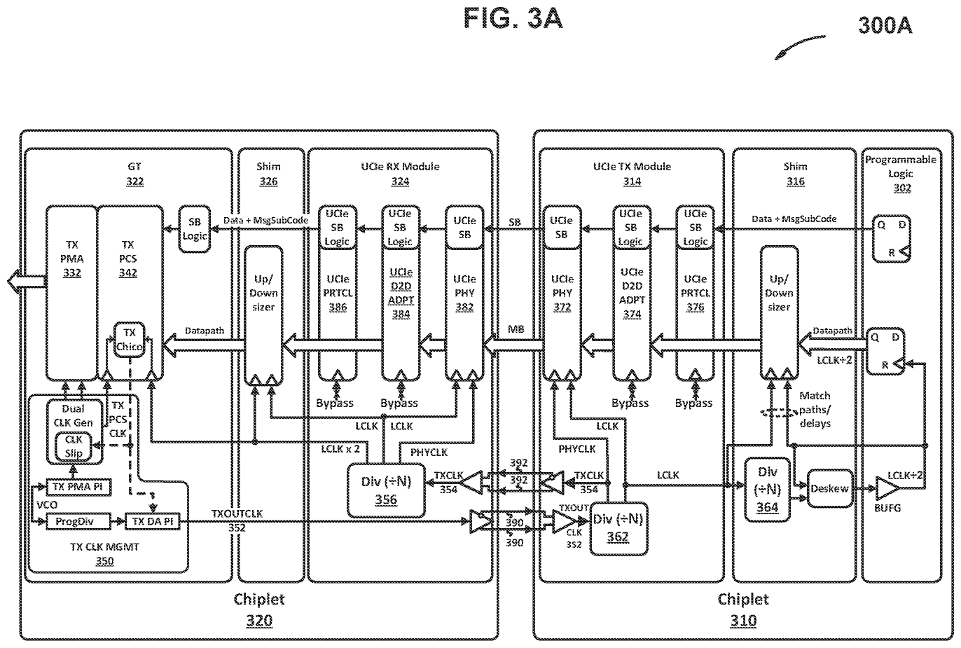

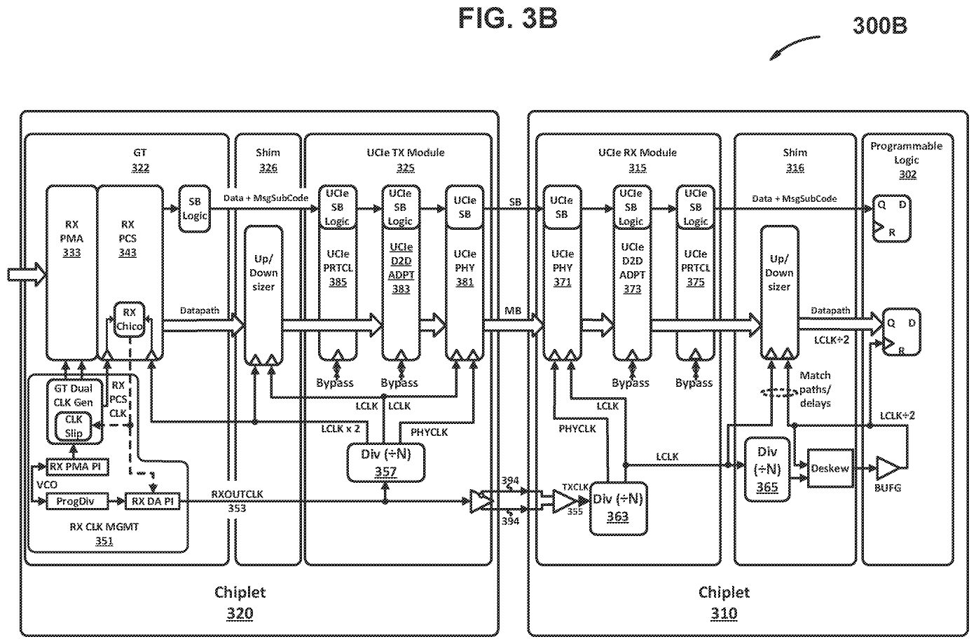

FIG. 2A illustrates a flowchart 200A illustrating a method for data transfer between two chiplets in transmit (TX) mode, according to an example. The method illustrated in the flowchart 200A will be described with reference to FIG. 3A.

FIG. 3A illustrates a block diagram of a system 300A showing portions of a chiplet 310 and portions of a chiplet 320 coupled to each other through UCIe interface modules in TX mode, according to an example. In TX mode, data is transmitted from the chiplet 310 (e.g., an anchor chiplet having programmable logic) to the chiplet 320 (e.g., a GMPC having one or more GTs). In one embodiment, the chiplets 310 and 320 shown in FIG. 3A may substantially correspond to the chiplets 110 and 120, respectively, in FIG. 1A.

In the present example, the chiplet 310 includes programmable logic 302 and a UCIe interface module. The UCIe interface module includes a UCIe TX interface module 314 (shown in FIG. 3A) and a UCIe RX interface module 315 (shown in FIG. 3B). Each of the UCIe TX interface module 314 and the UCIe RX interface module 315 includes a UCIe PHY layer, a UCIe D2D adapter layer, and a UCIe protocol layer. In another example, the UCIe interface module on the chiplet 310 may include a single module that operates in TX and/or RX modes.

In the present example, the chiplet 320 includes at least one GT 322 and a UCIe interface module. The UCIe interface module includes a UCIe RX interface module 324 (shown in FIG. 3A) and a UCIe TX interface module 325 (shown in FIG. 3B). Each of the UCIe RX interface module 324 and the UCIe TX interface module 325 includes a UCIe PHY layer, a UCIe D2D adapter layer, and a UCIe protocol layer. In another example, the UCIe interface module on the chiplet 320 may include a single module that operates in TX and/or RX modes.

As illustrated in FIG. 3A, the chiplet 310 may include a shim 316 between the programmable logic 302 and the UCIe TX interface module 314. The chiplet 320 may include a shim 326 between the GT 322 and the UCIe RX interface module 324. It should be understood that a shim architecture (e.g., the shim 316 or 326) may allow higher bit-width channels running at lower frequencies to be connected lower bit-width channels running at higher frequencies.

In the present example, the GT 322 includes a programmable physical media attachment (PMA) module, a programmable physical coding sub-layer (PCS) module, and a clock management module. The PMA module includes a programmable TX PMA module 332 (shown in FIG. 3A) and a programmable RX PMA module 333 (shown in FIG. 3B). The programmable PCS module includes a programmable TX PCS module 342 (shown in FIG. 3A) and a programmable RX PCS module 343 (shown in FIG. 3B). The clock management module includes a TX clock management module 350 (shown in FIG. 3A) and an RX clock management module 351 (shown in FIG. 3B). In another example, the programmable PMA module, the programmable PCS module, and the clock management module may each include a single module that operates in TX and/or RX modes.

In TX mode, the programmable TX PCS module 342 may receive TX data from the UCIe RX interface module 324 through the shim 326, and convert the data into the transmit parallel data, for example, in accordance with a TX PMA PCS interface setting. The programmable TX PMA module 332 may further convert the transmit parallel data from the programmable TX PCS module 342 into transmit serial data, for example, in accordance with a programmed serialization setting.

In TX mode, the TX clock management module 350 is operably coupled to the programmable TX PMA module 332 and the programmable TX PCS module 342. The TX clock management module 350 generates a TX clock (a transceiver-generated clock) and transmits the TX clock to the chiplet 310. The TX clock management module 350 also performs clock phase adjustments, for example, by using one or more built-in phase interpolators (PIs) in a phase-locked loop (PLL).

It is noted that the GT 322, the programmable logic 302 and the UCIe interface modules in the chiplets 310 and 320 may also include components for handling sideband (SB) logic and data, the details of which are omitted for brevity.

Referring back to FIG. 2A, in block 202, a transceiver on a first chiplet generates a clock, the clock being a TX Out Clock (TXOUTCLK) when the transceiver is in TX mode.

With reference to FIG. 3A, in TX mode, the TX clock management module 350 of the GT 322 on the chiplet 320 generates a TXOUTCLK 352 and provides it to the UCIe RX interface module 324 of the chiplet 320.

As shown in FIG. 3A, a voltage controlled oscillator (VCO) clock is provided to a TX PMA PI and a programmable divider (ProgDiv) in the TX clock management module 350. The VCO clock may be based on one or more reference clocks received by the GT 322. The one or more reference clocks may include, but are not limited to, an external clock, an internal clock of the GT 322, and/or a system clock. The TX PMA PI receives the VCO clock and provides a clock (e.g., a phase aligned clock) to a dual clock generator. The dual clock generator provides two clock signals to the programmable TX PMA module 332, and provides a transmit PCS clock (TX PCS CLK) to the programmable TX PCS module 342. The ProgDiv divides the VCO clock and provides the divided VCO clock to a TX delay aligner (DA) PI. The TX DA PI performs on-the-fly phase alignment and compensation for phase variations in the TXOUTCLK 352 due to, for example, voltage, temperature, and/or crystal variations.

In one example, the TXOUTCLK 352 has a frequency of 2.8 GHz. The TXOUTCLK 352's frequency may be related to the data line rate of the GT 322. In other examples, the TXOUTCLK 352's frequency may be higher or lower than 2.8 GHz.

Referring back to FIG. 2A, in block 204, the transceiver provides the TXOUTCLK from a first C2C interface module of the first chiplet to a second C2C interface module of a second chiplet through one or more clock transmission wires (e.g., auxiliary clock transmission wires).

With reference to FIG. 3A, the GT 322 provides the TXOUTCLK 352 from the UCIe RX interface module 324 of the chiplet 320 to the UCIe TX interface module 314 of the chiplet 310 through auxiliary clock transmission wires 390. As illustrated in FIG. 3A, the TXOUTCLK 352 is not altered by any of the PHY, D2D adapter, and protocol layers of the UCIe RX interface module 324 before it is transmitted to the UCIe TX interface module 314 of the chiplet 310. As a result, the characteristics of the TXOUTCLK 352 are maintained in the system 300A, as the TXOUTCLK 352 is transmitted directly from the chiplet 320 to the chiplet 310 through the UCIe interface modules without being converted to a UCIe PHY clock.

Referring back to FIG. 2A, in block 206, the second chiplet transmits the TXOUTCLK from the second C2C interface module of the second chiplet back to the first C2C interface module of the first chiplet through one or more clock transmission wires (e.g., the UCIe module transmit clock phase-1/transmit clock phase-2 (TXCKP/TXCKN) clock transmission wires as defined in the current UCIe interface specification), the TXOUTCLK being used as a TX clock (TXCLK) of the second chiplet.

With reference to FIG. 3A, after reaching the UCIe TX interface module 314 on the chiplet 310, the TXOUTCLK 352 is turned back around as a TX clock (TXCLK) 354 and transmitted from the UCIe TX interface module 314 on the chiplet 310 to the UCIe RX interface module 324 on the chiplet 320 through UCIe module TXCKP/TXCKN clock transmission wires 392. As shown in FIG. 3A, the TXOUTCLK 352 is provided to a divider 362 in the UCIe TX interface module 314 of the chiplet 310. The divider 362 provides the TXOUTCLK 352 (e.g., 2.82 GHz) as the TXCLK 354 to the UCIe module TXCKP/TXCKN clock transmission wires 392. As a result, the TXCLK 354 of the chiplet 310 (e.g., an anchor chiplet) is the same as the TXOUTCLK 352 of the chiplet 320 (e.g., a GMPC). It should be understood that, while the divider 362 is shown to be contained within the UCIe TX interface module 314 in FIG. 3A, in another example, the divider 362 may be a separate component outside of the UCIe TX interface module 314 on the chiplet 310.

Referring back to FIG. 2A, in block 208, the first chiplet locally generates a first logical clock (LCLK) from the TXCLK, and provides the first LCLK and a phase-shifted TXCLK (or the TXCLK) as a first PHY clock (PHYCLK) to a first UCIe PHY layer of the first C2C interface module.

With reference to FIG. 3A, the TXCLK 354 (e.g., 2.82 GHz), which is the same as the TXOUTCLK 352, is provided to a divider 356 in the UCIe RX interface module 324 on the chiplet 320. The divider 356 locally generates a logical clock (LCLK) on the chiplet 320 by dividing the TXCLK 354 by N (e.g., N=4), and provides the LCLK (e.g., 705 MHz) to the UCIe PHY layer 382 of the UCIe RX interface module 324. The divider 356 also provides a 90-degree phase shifted TXCLK as a UCIe PHY clock (PHYCLK) (e.g., 2.82 GHz) to the UCIe PHY layer 382 of the UCIe RX interface module 324. In another example, the divider 356 may provide the TXCLK as the UCIe PHY clock (PHYCLK) (e.g., 2.82 GHz) to the UCIe PHY layer 382 of the UCIe RX interface module 324. It should be understood that, while the divider 356 is shown to be contained within the UCIe RX interface module 324 in FIG. 3A, in another example, the divider 356 may be a separate component outside of the UCIe RX interface module 324 on the chiplet 320.

Referring back to FIG. 2A, in block 210, the second chiplet locally generates a second LCLK from the TXCLK, and provides the second LCLK and the TXCLK as a second PHYCLK to a second UCIe PHY layer of the second C2C interface module.

With reference to FIG. 3A, in the chiplet 310, the divider 362 locally generates a LCLK by dividing the TXCLK 354, which is the same as the TXOUTCLK 352 (e.g., 2.82 GHz), by N (e.g., N=4), and provides the LCLK (e.g., 705 MHz) to the UCIe PHY layer 372 of the UCIe TX interface module 314 on the chiplet 310. The divider 362 also provides the TXCLK 354 as a PHY clock (PHYCLK) to the UCIe PHY layer 372 of the UCIe TX interface module 314 of the chiplet 310. The PHYCLK and/or LCLK may be used for transmitting data in the UCIe main band (MB) from the UCIe TX interface module 314 to the UCIe RX interface module 324.

Referring back to FIG. 2A, in block 212, the second chiplet provides a divided second LCLK (or the second LCLK) to programmable logic on the second chiplet for transmitting data using a transceiver protocol implemented in the programmable logic.

With reference to FIG. 3A, a divider 364 divides the LCLK (e.g., 705 MHz) by N (e.g., N=2) and provides the divided LCLK (e.g., LCLK÷2) to the programmable logic 302. In another example, the shim 316 is optional, in which case the LCLK may be provided to the programmable logic 302 without division. In an example, the deskew between the UCIe clock domain and the programmable logic clock domain in the chiplet 310 may be handled by an AECG auxiliary clock IP.

Referring back to FIG. 2A, in block 214, the second chiplet transmits data from the programmable logic to the transceiver on the first chiplet through the second C2C interface module and first C2C interface module based on the TXOUTCLK.

With reference to FIG. 3A, the programmable logic 302 receives the divided clock (e.g., LCLK÷2) from the divider 364, and transmits data using the divided clock, which is based on the LCLK from the divider 362. The LCLK is provided by the divider 362 by dividing the TXOUTCLK 352 by N (e.g., N=4).

In the example shown in FIG. 3A, data is transmitted by the programmable logic 302 at the divided clock (e.g., 352.6 MHz). In TX mode, the data and clock from the programmable logic 302 may bypass the UCIe protocol layer 376 and at least a portion of the UCIe D2D adapter layer 374 of the UCIe TX interface module 314. For example, certain functions of the UCIe D2D adapter layer 374, such as data integrity check functions (e.g., parity check and cyclic redundancy check (CRC)), may not be bypassed. In another example, the programmable logic 302 may provide the data and clock directly to the UCIe PHY layer 372, bypassing the UCIe protocol layer 376 and the UCIe D2D adapter layer 374 of the UCIe TX interface module 314 entirely. Bypassing the UCIe protocol layer 376 and the UCIe D2D adapter layer 374 of the UCIe TX interface module 314 reduces latency of data transfer. In the example shown in FIG. 3A, the up/down-sizer in the shim 316 decreases the data width by half and doubles the clock frequency before providing the data and clock from the programmable logic 302 to the UCIe TX interface module 314. In another example, the shim 316 is optional, in which case the data and clock from the programmable logic 302 are directly provided to the UCIe PHY layer 372 of the UCIe TX interface module 314 without any data width or frequency modulations, thereby further reducing latency.

On the chiplet 320, the data and clock from the UCIe TX interface module 314 of the chiplet 310 are received by the UCIe PHY of the UCIe RX interface module 324. In the example shown in FIG. 3A, the data received by the UCIe RX interface module 324 is serialized (e.g., 8 to 1 serialization). After deserialization, the parallel data buses may each run at a lower frequency (e.g., 705 MHz).

As illustrated in FIG. 3A, in TX mode, the data and clock from the UCIe PHY layer 382 of the UCIe RX interface module 324 may bypass at least a portion of the UCIe D2D adapter layer 384 and the UCIe protocol layer 386 of the UCIe RX interface module 324 of the chiplet 320. For example, certain functions of the UCIe D2D adapter layer 384, such as data integrity check functions (e.g., parity check and CRC), may not be bypassed. In another example, the UCIe PHY layer 382 of the UCIe RX interface module 324 may provide the data and clock directly to the shim 326, bypassing the UCIe D2D adapter layer 384 and the UCIe protocol layer 386 of the UCIe RX interface module 324 entirely. Bypassing the UCIe D2D adapter layer 384 and the UCIe protocol layer 386 of the UCIe RX interface module 324 also reduces latency of data transfer.

In the example shown in FIG. 3A, the up/down-sizer in the shim 326 decreases the data width by half and doubles the clock frequency before providing the data from the UCIe RX interface module 324 to the GT 322. In another example, the shim 326 is optional, in which case the data and clock from the UCIe RX interface module 324 are directly provided to the GT 322 without any data width or frequency modulations, thereby further reducing latency.

Referring back to FIG. 2A, in block 216, the first chiplet performs clock phase adjustment to ensure synchronous data transfer by using one or more phase interpolators.

With reference to FIG. 3A, the divider 356 on the chiplet 320 provides another clock (e.g., LCLK×2) by dividing the TXCLK 354 (e.g., 2.82 GHz) by N (e.g., N=2), and provides the LCLK×2 (e.g., 1.41 GHz) to the up/down-sizer of the shim 326 and the programmable TX PCS module 342 of the GT 322.

The TX clock management module 350 is operably coupled to the programmable TX PMA module 332 and the programmable TX PCS module 342, and receives feedback through the programmable TX PCS module 342, thereby forming a PLL (e.g., an LCPLL). Based on the feedback in the PLL, the TX clock management module 350 performs clock phase adjustments (e.g., through the TX DA PI) to compensate for phase variations in the TXOUTCLK 352, for example, due to voltage, temperature, and/or crystal variations.

In the system 300A, the transceiver-generated clock (e.g., TXOUTCLK 352) is used as the UCIe PHY clock for data transfer. In other words, the clock generated by the GT 322 on the chiplet 320 does not need to be converted to a UCIe PHY clock before being provided to the programmable logic 302 residing on the chiplet 310. The TXOUTCLK 352 generated by the GT 322 is provided from the chiplet 320 to the chiplet 310. The divided TXOUTCLK 352 (e.g., LCLK÷2) is used by the programmable logic 302 to transmit data from the chiplet 310 to the chiplet 320 so that the characteristics (e.g., long-term jitters, etc.) of the TXOUTCLK 352 are maintained throughout the system 300A to ensure synchronous data transfer between the two chiplets.

FIG. 2B illustrates a flowchart 200B illustrating a method for data transfer between two chiplets in receive (RX) mode, according to an example. The method illustrated in the flowchart 200B will be described with reference to FIG. 3B.

FIG. 3B is a block diagram of a system 300B showing portions of the chiplet 310 and portions of the chiplet 320 coupled to each other through the UCIe interface modules in RX mode, according to an example. In RX mode, data received by the chiplet 320 (e.g., a GMPC having one or more GTs) is transmitted to the chiplet 310 (e.g., an anchor chiplet having programmable logic). In one embodiment, the chiplets 310 and 320 shown in FIG. 3B may substantially correspond to the chiplets 110 and 120, respectively, in FIG. 1A.

As illustrated in FIG. 3B, the chiplet 310 includes the programmable logic 302 and the UCIe RX interface module 315. The chiplet 310 may include the shim 316 between the programmable logic 302 and the UCIe RX interface module 315. The chiplet 320 includes at least one GT 322 and the UCIe TX interface module 325. The chiplet 320 may include the shim 326 between the GT 322 and the UCIe TX interface module 325.

In RX mode, the programmable RX PMA module 333 may receive serial data, and convert the received serial data into received parallel data, for example, in accordance with a programmed deserialization setting. The programmable RX PCS module 343 may convert the received parallel data from the programmable RX PMA module 333 into received serial data in accordance with an RX PMA_PCS interface setting.

In RX mode, the RX clock management module 351 is operably coupled to the programmable RX PMA module 333 and the programmable RX PCS module 343. The RX clock management module 351 generates an RX clock (a transceiver-generated clock) and transmits the RX clock to the chiplet 310. The RX clock management module 351 performs clock phase adjustments, for example, by using one or more built-in PIs in a PLL.

Referring back to FIG. 2B, in block 222, a transceiver on a first chiplet generates a clock, the clock being an RX Out Clock (RXOUTCLK) when the transceiver is in RX mode.

With reference to FIG. 3B, in RX mode, the RX clock management module 351 of the GT 322 on the chiplet 320 generates an RXOUTCLK 353 and provides it to the UCIe TX interface module 325 of the chiplet 320.

As shown in FIG. 3B, a VCO clock is provided to an RX PMA PI and a ProgDiv in the RX clock management module 351. The VCO clock may be based on one or more reference clocks received by the GT 322. The one or more reference clocks may include, but are not limited to, an external clock, an internal clock of the GT 322, and/or a system clock. The RX PMA PI receives the VCO clock and provides a clock (e.g., a phase aligned clock) to a dual clock generator. The dual clock generator provides two clock signals to the programmable RX PMA module 333, and provides an RX PCS CLK to the programmable RX PCS module 343. The ProgDiv divides the VCO clock and provides the divided VCO clock to an RX DA PI. The RX DA PI performs on-the-fly phase alignment and compensation for phase variations in the RXOUTCLK 353 due to, for example, voltage, temperature, and/or crystal variations.

In one example, the RXOUTCLK 353 has a frequency of 2.8 GHz. The RXOUTCLK 353's frequency may be related to the data line rate of the GT 322. In other examples, the RXOUTCLK 353's frequency may be higher or lower than 2.8 GHz.

Referring back to FIG. 2B, in block 224, the transceiver provides the RXOUTCLK from a first C2C interface module of the first chiplet to a second C2C interface module of a second chiplet through one or more clock transmission wires (e.g., the UCIe module TXCKP/TXCKN clock transmission wires as defined in the current UCIe interface specification), where the RXOUTCLK is used as a TX clock (TXCLK) by the first C2C interface.

With reference to FIG. 3B, the GT 322 provides the RXOUTCLK 353 from the UCIe TX interface module 325 of the chiplet 320 to the UCIe RX interface module 315 of the chiplet 310 through UCIe module TXCKP/TXCKN clock transmission wires 394. As illustrated in FIG. 3B, the RXOUTCLK 353 is not altered by any of the PHY, D2D adapter, and protocol layers of the UCIe TX interface module 325 before it is transmitted to the UCIe RX interface module 315 of the chiplet 310. As a result, the characteristics of the RXOUTCLK 353 are maintained in the system 300B, as the RXOUTCLK 353 is transmitted directly from the chiplet 320 to the chiplet 310 through the UCIe interface modules without being converted to a UCIe PHY clock.

Referring back to FIG. 2B, in block 226, the first chiplet locally generates a first logical clock (LCLK) from the RXOUTCLK, and provides the first LCLK and the RXOUTCLK as a first PHY clock (PHYCLK) to a first PHY layer of the first C2C interface module.

With reference to FIG. 3B, the RXOUTCLK 353 (e.g., 2.82 GHz) is provided to a divider 357 in the UCIe TX interface module 325. The divider 357 locally generates a first logical clock (e.g., LCLK) on the chiplet 320 by dividing the RXOUTCLK 353 by N (e.g., N=4), and provides the LCLK (e.g., 705 MHz) to the UCIe PHY layer 381 of the UCIe TX interface module 325. The divider 357 also provides the RXOUTCLK 353 as a first PHY clock (PHYCLK) (e.g., 2.82 GHz) to the UCIe PHY layer 381 of the UCIe TX interface module 325. It should be understood that, while the divider 357 is shown to be contained within the UCIe TX interface module 325 in FIG. 3B, in another example, the divider 357 may be a separate component outside of the UCIe TX interface module 325 on the chiplet 320.

Referring back to FIG. 2B, in block 228, the first chiplet performs clock phase adjustment to ensure synchronous data transfer by using one or more phase interpolators.

With reference to FIG. 3B, the divider 357 on the chiplet 320 provides the LCLK (e.g., 705 MHz) to the UCIe PHY layer 381 of the UCIe TX interface module 325 and the up/downsizer in the shim 326. The divider 357 also divides the RXOUTCLK 353 by N (e.g., N=2), and provides the divided RXOUTCLK 353 (e.g., LCLK×2) to the up/downsizer in the shim 326 and the programmable RX PCS module 343 of the GT 322.

The RX clock management module 351 is operably coupled to the programmable RX PMA module 333 and the programmable RX PCS module 343, and receives feedback through the programmable RX PCS module 343, thereby forming a PLL (e.g., an LCPLL). Based on the feedback in the PLL, the RX clock management module 351 performs clock phase adjustments (e.g., through the RX DA PI) to compensate for phase variations in the RXOUTCLK 353, for example, due to voltage, temperature, and/or crystal variations.

Referring back to FIG. 2B, in block 230, the second chiplet locally generates a second LCLK from the TXCLK, and provides the second LCLK and the TXCLK as a second PHY clock (PHYCLK) to a second PHY layer of the second C2C interface module.

With reference to FIG. 3B, in the chiplet 310, the TXCLK 355, which is the same as the RXOUTCLK 353 (e.g., 2.82 GHz), is provided to a divider 363 in the UCIe RX interface module 315 on the chiplet 310. The divider 363 provides the TXCLK 355 as a second PHY clock (e.g., PHYCLK) to the UCIe PHY layer 371 of the UCIe RX interface module 315. The divider 363 also divides the TXCLK 355 by N (e.g., N=4) to generate a logical clock (e.g., LCLK), and provides the LCLK (e.g., 705 MHz) to the UCIe PHY layer 371 of the UCIe RX interface module 315. It should be understood that, while the divider 363 is shown to be contained within the UCIe RX interface module 315 in FIG. 3B, in another example, the divider 363 may be a separate component outside of the UCIe RX interface module 315 on the chiplet 310.

Referring back to FIG. 2B, in block 232, the second chiplet provides a divided second LCLK (or the second LCLK) to the programmable logic on the second chiplet for receiving data using a transceiver protocol implemented in the programmable logic.

With reference to FIG. 3B, a divider 365 divides the LCLK (e.g., 705 MHz) by N (e.g., N=2) and provides the divided LCLK (e.g., LCLK÷2) to the programmable logic 302. In another example, the shim 316 is optional, in which case the LCLK may be provided to the programmable logic 302 without division. In an example, the deskew between the UCIe clock domain and the programmable logic clock domain in the chiplet 310 may be handled by an AECG auxiliary clock IP.

Referring back to FIG. 2B, in block 234, the first chiplet transmits data from the transceiver to the programmable logic on the second chiplet through the first C2C interface module and second C2C interface module based on the RXOUTCLK.

With reference to FIG. 3B, the GT 322 transmits data and a clock to the shim 326. In RX mode, the data and clock from the shim 326 may bypass the UCIe protocol layer 385 and at least a portion of the D2D adapter layer 383 of the UCIe TX interface module 325. For example, certain functions of the UCIe D2D adapter layer 383, such as data integrity check functions (e.g., parity check and CRC), may not be bypassed. In another example, the GT 322 may provide the data and clock directly to the UCIe PHY layer 381 bypassing the UCIe protocol layer 385 and the UCIe D2D adapter layer 383 of the UCIe TX interface module 325 entirely. Bypassing the UCIe protocol layer 385 and the UCIe D2D adapter layer 383 of the UCIe TX interface module 325 reduces latency of data transfer.

In the example shown in FIG. 3B, the up/down-sizer in the shim 326 doubles the data width and decreases the clock frequency by half before providing the data and clock from the GT 322 to the UCIe TX interface module 325. In another example, the shim 326 is optional, in which case the data and clock from the GT 322 are directly provided to the UCIe PHY layer 381 of the UCIe TX interface module 325 without any data width or frequency modulations, thereby further reducing latency.

The data and clock from the UCIe TX interface module 325 of the chiplet 320 are received by the UCIe PHY layer 371 of the UCIe RX interface module 315 of the chiplet 310. In the example shown in FIG. 3B, the data received by the UCIe RX interface module 315 is serialized (e.g., 8 to 1 serialization). After deserialization, the parallel data buses may each run at a lower frequency (e.g., 705 MHz).

As illustrated in FIG. 3B, in RX mode, the data and clock from the UCIe PHY layer 371 of the UCIe RX interface module 315 may bypass at least a portion of the UCIe D2D adapter layer 373 and the UCIe protocol layer 375 of the UCIe RX interface module 315 of the chiplet 310 before being provided the shim 316. For example, certain functions of the UCIe D2D adapter layer 373, such as data integrity check functions (e.g., parity check and CRC), may not be bypassed. In another example, the UCIe PHY layer 371 of the UCIe RX interface module 315 may provide the data and clock directly to the shim 316, bypassing the UCIe D2D adapter layer 373 and the UCIe protocol layer 375 of the UCIe RX interface module 315 entirely. Bypassing the UCIe D2D adapter layer 373 and the UCIe protocol layer 375 of the UCIe RX interface module 315 also reduces latency of data transfer.

In the example shown in FIG. 3B, the up/down-sizer in the shim 316 decreases the clock frequency by half and doubles the data width before providing the data and clock from the UCIe RX interface module 315 to the programmable logic 302. In yet another example, the shim 316 is optional, in which case the data and clock from the UCIe PHY layer 371 of the UCIe RX interface module 315 are directly provided to the programmable logic 302 without any data width or frequency modulations, thereby further reducing latency.

In the system 300B, the transceiver-generated clock (e.g., the RXOUTCLK 353) is used as the UCIe PHY clock for data transfer. In other words, the clock generated by the GT 322 on the chiplet 320 does not need to be converted to a UCIe PHY clock before being provided to the programmable logic 302 residing on the chiplet 310. In the chiplet 310, the divided RXOUTCLK 353 (e.g., LCLK÷2) is used by the programmable logic 302 to receive data from the GT 322. As such, the characteristics (e.g., long-term jitters, etc.) of the RXOUTCLK 353 are maintained throughout the system 300B to ensure synchronous data transfer between the two chiplets.

Referring back to FIG. 2B, in block 236, the first chiplet may optionally perform multi-module alignment among two or more transceivers before data from the transceivers is provided to the first C2C interface module of the first chiplet. For example, when the first chiplet includes multiple transceivers, the first chiplet may include alignment circuitry to align data from different transceivers before providing the data to the UCIe interface modules.

In block 238, the second chiplet may optionally perform multi-lane alignment before data is provided to the programmable logic. For example, when the first chiplet includes multiple transceivers, the second chiplet may include alignment circuitry to align data received through different lanes from the UCIe interface modules on the second chiplet before providing the data to the programmable logic.

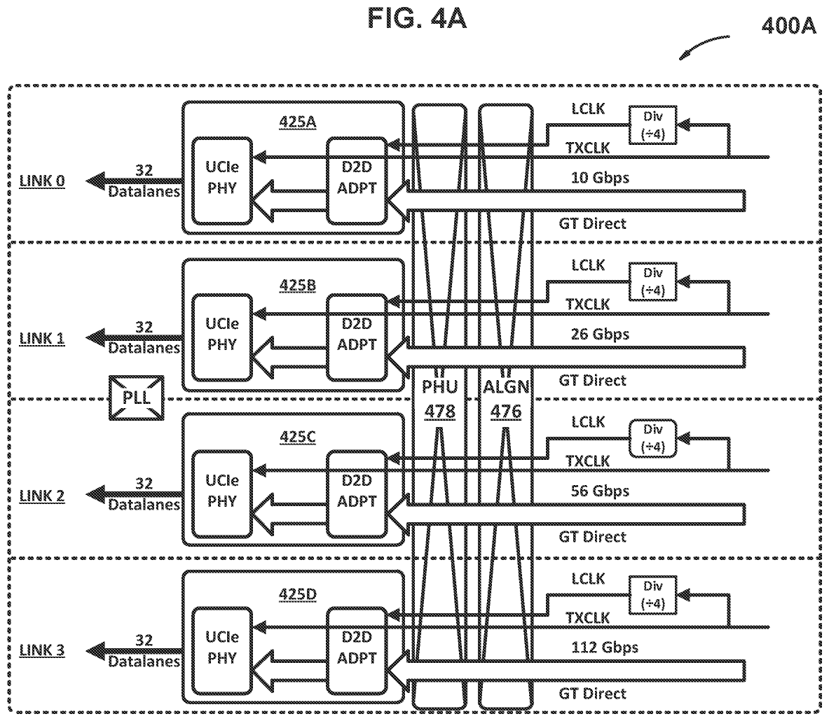

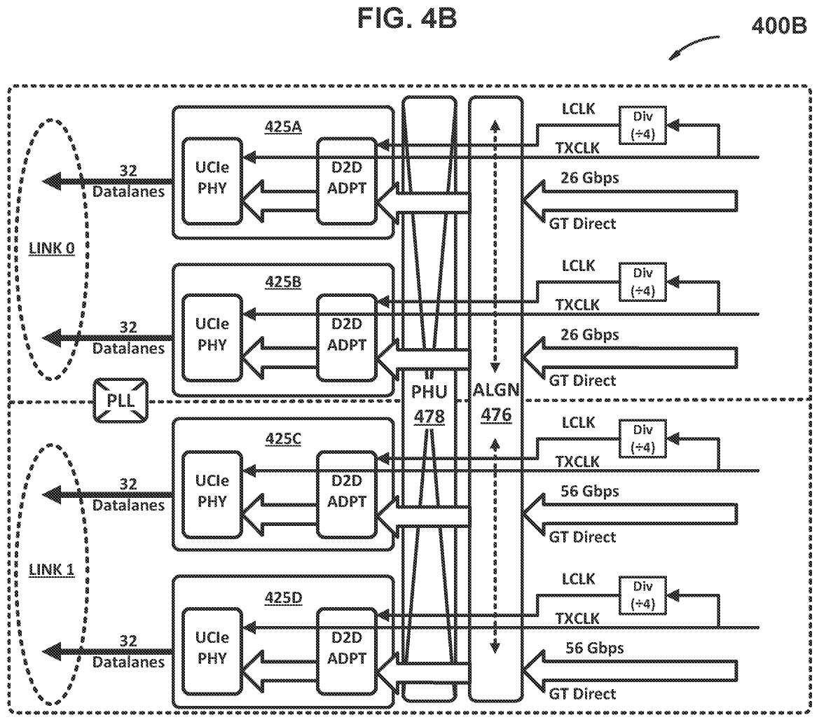

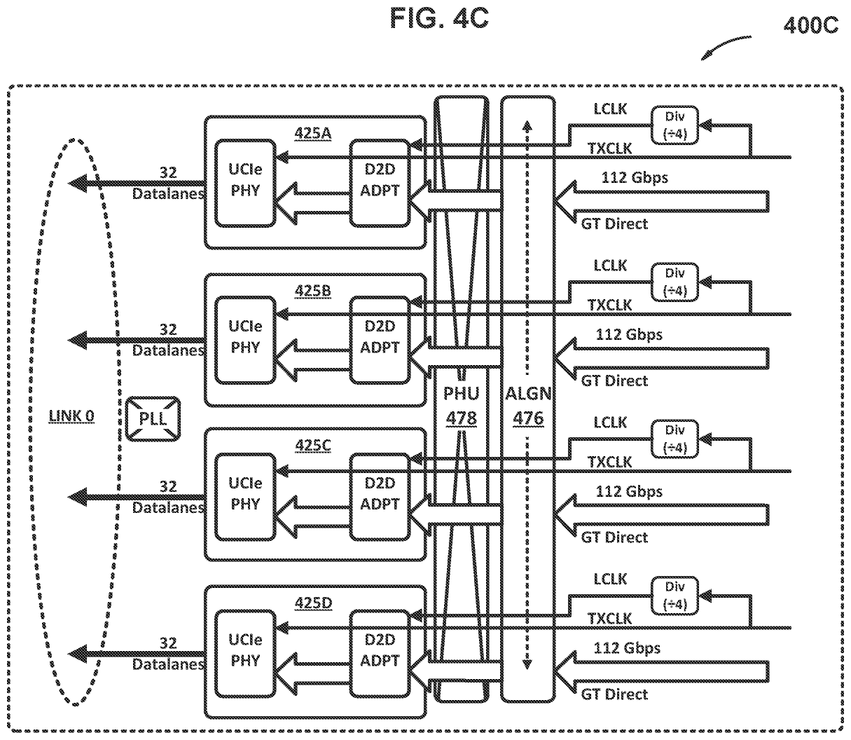

Referring now to FIGS. 4A-4C, FIG. 4A illustrates a block diagram 400A of four UCIe interface modules providing data through four independent GT links or channels, according to an example. FIG. 4B illustrates a block diagram 400B of four UCIe interface modules combined to provide two independent GT direct links or channels, according to another example. FIG. 4C illustrates a block diagram 400C of four UCIe interface modules combined to provide a single independent GT direct link or channel, according to yet another example.

As illustrated in FIGS. 4A-4C, UCIe interface modules 425A, 425B, 425C, and 425D (collectively referred to as “the UCIe interface modules 425”) each include a UCIe PHY layer and a UCIe D2D adapter layer. Each of the UCIe interface modules 425 may also include a UCIe protocol layer, which is bypassed in the examples shown in FIGS. 4A-4C, thus omitted for clarity.

In the examples shown in FIGS. 4A-4C, each of the UCIe interface modules 425 receives data from a GT (not explicitly shown) through 4 datapaths. The data from two or more modules may be aligned by an alignment module 476 before being provided to the UCIe interface modules 425. In the examples shown in FIGS. 4A-4C, the chiplets are in a GT direct mode, (e.g., where a protocol handling unit (PHU) 478 is not required, thus bypassed). Each of the UCIe PHY layer runs in an 8:1 mode, where each datapath is split into 8 data lanes. As a result, each of the UCIe PHY layers outputs data through 32 data lanes.

In addition, the UCIe interface modules 425 may each receive a different high-speed clock provided by the PLLs in their respective GTs. The high-speed clock from the GT is used as the UCIe PHY clock. Thus, a UCIe PLL is not required. A logical clock (LCLK) is generated by dividing the high-speed clock by using a divider (e.g., a 0.4 divider) in each of the UCIe interface modules 425.

As illustrated in FIG. 4A, the UCIe interface modules 425 may receive data having different data widths from their respective GTs and different clock frequencies as the GTs may have different channel types or protocols. For example, the UCIe interface modules 425A, 425B, 425C, and 425D receive data at 10 Gbps, 26 Gbps, 56 Gbps, and 112 Gbps, respectively. In the example shown in FIG. 4A, the TXCLK has a frequency range of about 2.00 GHz to about 2.82 GHz. Each datapath clock (e.g., LCLK) has a frequency range of about 500 MHz to about 705 MHz (e.g., 4 datapaths per GT).

As illustrated in FIG. 4A, the first GT direct link (e.g., LINK 0) outputs data at 10 Gbps through 32 data lanes, the second GT direct link (e.g., LINK 1) outputs data at 26 Gbps through 32 data lanes, the third GT direct link (e.g., LINK 2) outputs data at 56 Gbps through 32 data lanes, and the fourth GT direct link (e.g., LINK 3) outputs data at 112 Gbps through 32 data lanes.

In the example shown in FIG. 4A, since each of the UCIe interface modules 425 receives data having different data widths, protocols, and/or clock frequencies, the alignment module 476 is not used, thus bypassed.

As illustrated in FIG. 4B, the UCIe interface modules 425A and 425B receive data having the same data width from their respective GTs. For example, the UCIe interface modules 425A and 425B each receive data from their respective GTs (not explicitly shown) at 26 Gbps. In addition, the UCIe interface modules 425A and 425B receive the same high-speed clock, TXCLK, generated by an LCPLL in each GT. For example, the UCIe interface modules 425A and 425B run at the same clock frequency because the GTs coupled to the UCIe interface modules 425A and 425B are of the same channel type and protocol. In the present example, the LCLKs in the UCIe interface modules 425A and 425B are also the same. Additionally, link controls for the UCIe interface modules 425A and 425B are also combined, for example, with one FDI designated as primary and another FDI designated as secondary. The link controls can be provided in parallel to each FDI.

Similarly, the UCIe interface modules 425C and 425D may receive data having the same data width from their respective GTs (not explicitly shown) at 56 Gbps. In addition, the UCIe interface modules 425C and 425D receive the same high-speed clock, TXCLK, generated by an LCPLL in each GT. For example, the UCIe interface modules 425C and 425D run at the same clock frequency because the GTs coupled to the UCIe interface modules 425C and 425D are of the same channel type and protocol. In the present example, the LCLKs in the UCIe interface modules 425C and 425D are also the same. Additionally, link controls for the UCIe interface modules 425C and 425D are also combined, for example, with one FDI designated as primary and another FDI designated as secondary. The link controls can be provided in parallel to each FDI.

In the example shown in FIG. 4B, framing patterns are added to the UCIe interface modules 425. The alignment module 476 is used to perform alignment based on the framing patterns. For example, data from the first and second GTs is aligned by the alignment module 476 before it is provided to the UCIe interface modules 425A and 425B. The UCIe interface modules 425A and 425B are combined together and provide a GT direct link or channel. Also, data from the third and fourth GTs is aligned by the alignment module 476 before they is provided to the UCIe interface modules 425C and 425D. The UCIe interface modules 425C and 425D are combined together and provide another GT direct link or channel. As such, the first GT direct link (e.g., LINK 0) outputs data (e.g., phase-aligned data) at 52 Gbps through 64 data lanes, and the second GT direct link (e.g., LINK 1) outputs data (e.g., phase-aligned data) at 112 Gbps through 64 data lanes.

As illustrated in FIG. 4C, all four of the UCIe interface modules 425 receive data having the same data width from their respective GTs. For example, the UCIe interface modules 425 each receive data from their respective GTs (not explicitly shown) at 112 Gbps. In addition, the UCIe interface modules 425 receive the same high-speed clock, TXCLK, generated by an LCPLL in each GT. For example, the UCIe interface modules 425 run at the same clock frequency because the GTs coupled to the UCIe interface modules 425 are of the same channel type and protocol. In the present example, the LCLKs in all four of the UCIe interface modules 425 are the same.

In the example shown in FIG. 4C, framing patterns are added to the UCIe interface modules 425. The alignment module 476 is used to perform alignment based on the framing patterns. For example, data from the four GTs is aligned by the alignment module 476 before it is provided to the UCIe interface modules 425. The four UCIe interface modules 425 are combined together and provide a single GT direct link or channel. As such, the GT direct link (e.g., LINK 0) outputs data (e.g., phase-aligned data) at 448 Gbps using 128 data lanes. Additionally, link controls for all four of the UCIe interface modules 425 are also combined, for example, with one FDI designated as primary and the rest of the FDIs designated as secondary. The link controls can be provided in parallel to each FDI.

In the examples shown in FIGS. 4A-4C, a UCIe PLL is not required as the UCIe TXCLK in each of the UCIe interface modules 425 is the same as the high-speed clock, TXCLK, generated by a PLL (e.g., an LCPLL) in each GT. Also, in the examples shown in FIGS. 4A-4C, in the GT direct mode, the high-speed clock, TXCLK, in each UCIe interface module 425 is directly transmitted to the UCIe PHY layer bypassing the UCIe protocol layer and the D2D adapter layer. The logical clock (LCLK) in each UCIe interface module may also bypass the UCIe protocol layer and at least a portion of the D2D adapter layer. In another example, the logical clock in each UCIe interface module may be provided directly to the UCIe PHY layer bypassing the UCIe protocol layer and the D2D adapter layer entirely.

In the examples shown in FIGS. 4A-4C, the GT high-speed clocks (e.g., TXCLK) in the UCIe interface modules 425 are used throughout the system for various protocols (e.g., High Speed Serial Input/Output (HSSIO) protocols) implemented in the programmable logic. As a result, the clock parts per million (PPM) is maintained. Also, by using the alignment module 476 to provide synchronous interfacing, latency is further reduced.

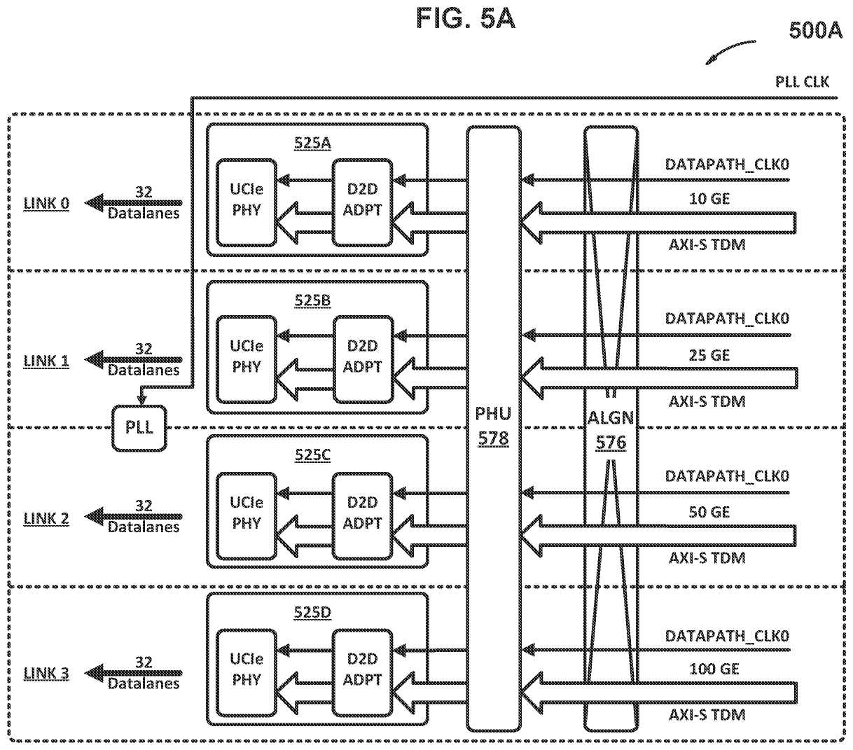

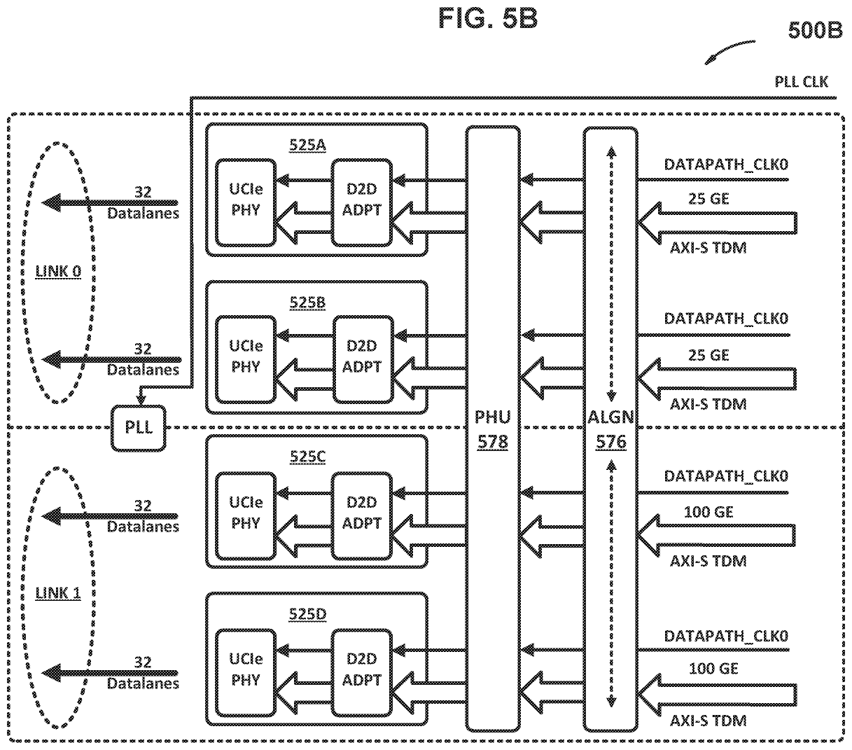

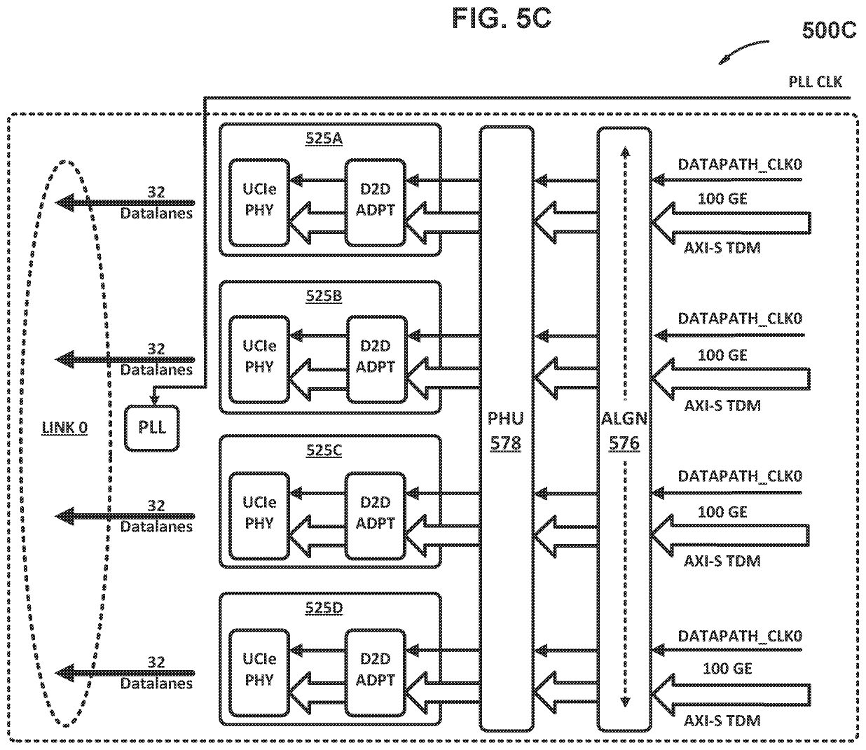

Referring now to FIGS. 5A-5C, FIG. 5A illustrates a block diagram 500A of four UCIe interface modules providing data through four independent Ethernet links or channels, according to an example. FIG. 5B illustrates a block diagram 500B of four UCIe interface modules combined to provide data through two independent Ethernet links or channels, according to another example. FIG. 5C illustrates a block diagram 500C of four UCIe interface modules combined to provide data through a single independent Ethernet link or channel, according to yet another example.

As illustrated in FIGS. 5A-5C, UCIe interface modules 525A, 525B, 525C, and 525D (collectively referred to as “the UCIe interface modules 525”) each include a UCIe PHY layer and a UCIe D2D adapter layer. Each of the UCIe interface modules 525 may also include a UCIe protocol layer, which is bypassed in the examples shown in FIGS. 5A-5C, thus omitted for clarity.

In the examples shown in FIGS. 5A-5C, each UCIe interface module 525 receives data from an Advanced eXtensible Interface 4 (AXI4)-Stream (AXI-S). The data may include two or more time division multiplexed (TMD) streaming signals, and may be provided to each UCIe interface module 525 through 4 datapaths. The data from two or more modules may be aligned by an alignment module 576 before being provided to a PHU 578. The alignment module 576 may align two or more datapaths by using alignment logic (e.g., AECG alignment logic). The PHU 578 may perform one or more features, including but are not limited to lane steering (e.g., inter-data word lane steering), framing (e.g., up-to 4 DW framing), error protection (e.g., parity check), flow control (e.g., conversion between handshake based flow control at an upper layer to credit based at the data word level), and clocks (e.g., where the protocol layer assumes a different clock from the PL/Hard logic and where a same clock is required per PHY). Thereafter, the data is provided from the PHU 578 to the UCIe interface modules 525. Each of the UCIe PHY layer runs in an 8:1 mode, where each datapath is split into 8 data lanes. As a result, each of the UCIe PHY layers outputs data through 32 data lanes.

In addition, as illustrated in FIGS. 5A-5C, each of the UCIe interface modules 525 may receive a datapath clock (e.g., DATAPATH_CLK0). In some examples, all datapaths use a single clock sourced from a ChipMAC or PCIe. In some examples, an AECG PLL is used to provide a logical clock (LCLK) to the UCIe PLL. The UCIe PLL generates the PHY clock.

As illustrated in FIG. 5A, the AXI-S TMD data provided to the UCIe interface modules 525 have different data widths and different clock frequencies as the data may be of different channel types or protocols. For example, the UCIe interface modules 525A, 525B, 525C, and 525D receive data at 10 Gigabit Ethernet (GE), 25 GE, 50 GE, and 100 GE, respectively.

In the example shown in FIG. 5A, since the AXI-S TDM data have different data widths and/or different protocols, the alignment module 576 is not used. Hence, the AXI-S TDM data is provided to the PHU 578. The PHU 578 then provides the data to the UCIe interface modules 525. For example, the data is provided to the UCIe D2D adapter layer and the UCIe PHY layer of the UCIe interface modules 525, bypassing the UCIe protocol layer (not explicitly shown in FIG. 5A).

As illustrated in FIG. 5A, the first link (e.g., LINK 0) outputs data at 10 GE through 32 data lanes, the second link (e.g., LINK 1) outputs data at 25 GE through 32 data lanes, the third link (e.g., LINK 2) outputs data at 50 GE through 32 data lanes, and the fourth link (e.g., LINK 3) outputs data at 100 GE through 32 data lanes.

As illustrated in FIG. 5B, the UCIe interface modules 525A and 525B receive AXI-S TMD data having the same data width (e.g., at 25 GE). The UCIe interface modules 525A and 525B receive the same datapath clock (e.g., DATAPATH_CLK0). Link controls for the UCIe interface modules 525A and 525B are also combined, for example, with one FDI designated as primary and another FDI designated as secondary. In addition, the UCIe interface modules 525C and 525D receive AXI-S TMD data having the same data width (e.g., at 100 GE). The UCIe interface modules 525C and 525D receive the same datapath clock (e.g., DATAPATH_CLK0). Link controls for the UCIe interface modules 525C and 525D are also combined, for example, with one FDI designated as primary and another FDI designated as secondary.

In the example shown in FIG. 5B, framing patterns are added to the UCIe interface modules 525. The alignment module 576 is used to perform alignment based on the framing patterns. For example, the AXI-S TDM data provided to the UCIe interface modules 525A and 525B is aligned by the alignment module 576 before being provided to the PHU 578. Also, the AXI-S TDM data provided to the UCIe interface modules 525C and 525D is aligned by the alignment module 576 before being provided to the PHU 578. The PHU 578 then provides the data to the UCIe D2D adapter layer and the UCIe PHY layer of the UCIe interface modules 525, bypassing the UCIe protocol layer (not explicitly shown in FIG. 5B).

As illustrated in FIG. 5B, the UCIe interface modules 525A and 525B are combined together and provide an Ethernet link (e.g., LINK 0). Also, the UCIe interface modules 525C and 525D are combined together and provide another Ethernet link (e.g., LINK 1). As each of the UCIe PHY layers outputs data in 32 data lanes, the first Ethernet link (e.g., LINK 0) outputs data (e.g., phase-aligned data) at 50 GE through 64 data lanes, and the second Ethernet link (e.g., LINK 1) outputs data (e.g., phase-aligned data) at 200 GE through 64 data lanes.

As illustrated in FIG. 5C, all four of the UCIe interface modules 525 receive AXI-S TMD data having the same data width (e.g., at 100 GE) and the same datapath clock (e.g., DATAPATH_CLK0). Additionally, link controls for all four of the UCIe interface modules 525 are also combined, for example, with one FDI designated as primary and the rest of the FDIs designated as secondary.

In the example shown in FIG. 5C, framing patterns are added to the UCIe interface modules 525. The alignment module 576 is used to perform alignment based on the framing patterns. For example, the AXI-S TDM data provided to all four of the UCIe interface modules 525 is aligned by the alignment module 576 before being provided to the PHU 578. The PHU 578 then provides the data to the UCIe D2D adapter layer and the UCIe PHY layer of the UCIe interface modules 525, bypassing the UCIe protocol layer (not explicitly shown in FIG. 5C).

As illustrated in FIG. 5C, the UCIe interface modules 525A, 525B, 525C, and 525D are combined together and provide a single Ethernet link (e.g., LINK 0). As each of the UCIe PHY layers outputs data in 32 data lanes, the Ethernet link (e.g., LINK 0) outputs data (e.g., phase-aligned data) at 400 GE through 128 data lanes. In one example, the combined datapath may be aligned onto the same clock domain in the programmable logic at a frequency between 350 MHz and 500 MHz.

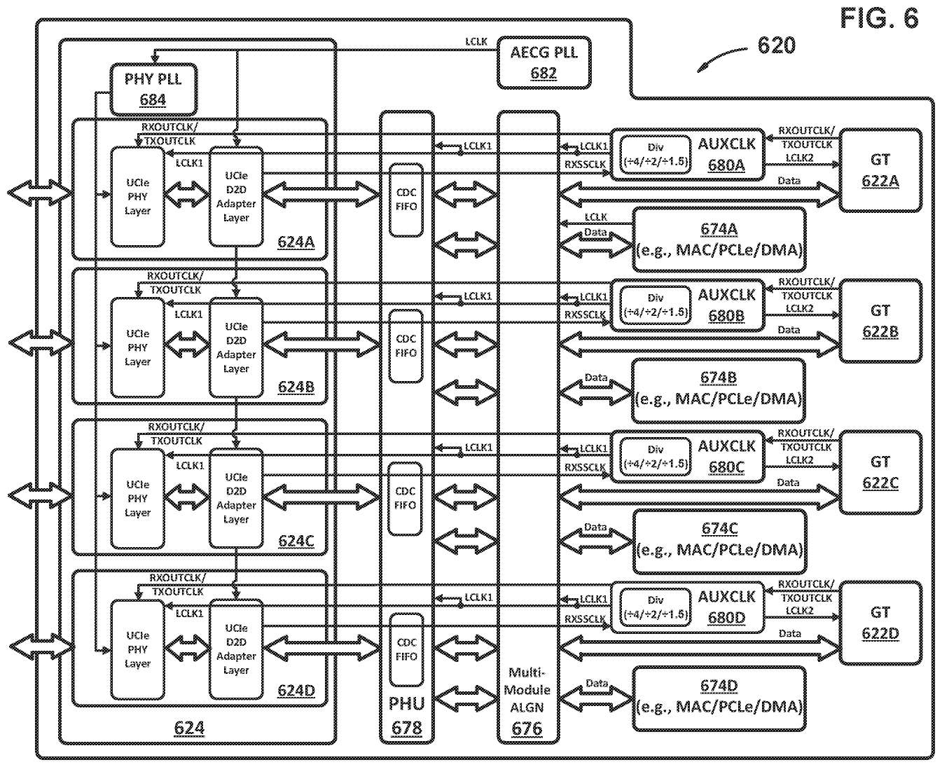

FIG. 6 illustrates a block diagram of a chiplet 620, according to an example. In the example shown in FIG. 6, the chiplet 620 is a GMPC that is capable of provide a variety of connectivity solutions for another chiplet (e.g., an anchor chiplet or another GMPC) via a UCIe interface module. In the one embodiment, the chiplet 620 may substantially correspond to the chiplet 120 in FIG. 1A.

As illustrated in FIG. 6, the chiplet 620 includes GTs 622A, 622B, 622C, and 622D (collectively referred to “the GTs 622”), and UCIe interface modules 624A, 624B, 624C, and 624D (collectively referred to “the UCIe interface modules 624”). The chiplet 620 also includes multi-module alignment circuitry 676 and a PHU 678 between the GTs 622 and the UCIe interface modules 624. The GTs 622A, 622B, 622C, and 622D are respectively coupled to auxiliary clock modules 680A, 680B, 680C, and 680D (collectively referred to “the auxiliary clock modules 680”).

The chiplet 620 may also include other hard intellectual property (IP) blocks 674A, 674B, 674C, and 674D (collectively referred to “the hard IP blocks 674”). By way of example only, the hard IP blocks 674 may include one or more of a PCIe/CCIX MAC core associated with a PS and DMA engines and controllers. The chiplet 620 may also include other interfaces, such as PCIe Gen6 AXI-S and DMA AXI-MM interfaces (not explicitly shown in FIG. 6) with many possible bifurcation configurations (e.g., x2, x4, x8, x16, or any combination thereof). In some embodiments, the chiplet 620 may include an Ethernet MAC AXI-S with a variety of possible port configurations (e.g., 10G, 25G, 50G, 100G, 200G, 400G, 800G, 1.6T, etc.).

In the GT direct mode, a GT LCPLL within each GT 622 generates a TXOUTCLK or RXOUTCLK. A logical clock (e.g., LCLK1) is generated by the auxiliary clock module 680 associated with each GT 622. For example, the LCLK1 may be generated by dividing the TXOUTCLK or RXOUTCLK by N (e.g., N=4). The LCLK1 may be provided to the multi-module alignment circuitry 676 and the UCIe PHY layer of the UCIe interface module 624. While the PHU 678 is bypassed in the GT direct mode, the LCLK1 may be also provided to the PHU 678 in another embodiment (e.g., when the chiplet 620 is in a PHU mode).

In a GT direct TX mode, the TXOUTCLK is provided directly to an anchor chiplet, and used as a TXCLK on the anchor chiplet for transmitting data to the chiplet 620. In the GT direct TX mode, data is received through multiple lanes by the UCIe PHY layer in each of the UCIe interface modules 624. For example, each UCIe PHY layer may receive data through 32 data lanes. Within each UCIe interface module 624, a first level of deskew may be performed to align data received through different data lanes before the data is passed to upper levels. Framing patterns may be added so that the multi-module alignment circuitry 676 can align data among two or more of the UCIe interface modules 624 before the data is sent to the GTs 622 for transmission.

In a GT direct RX mode, the RXOUTCLK is provided to the UCIe PHY layer and used directly as a UCIe PHY clock (PHYCLK) in the UCIe interface module 624. Also, data received from two or more of the GTs 622 may be aligned by the multi-module alignment circuitry 676 before being provided to the UCIe interface modules 624.

As shown in FIG. 6, the UCIe D2D adapter layer of each UCIe interface module 624 may provide an RXSSCLK to the auxiliary clock module 680. The auxiliary clock module 680 then provides a LCLK2 based on the RXSSCLK. Each GT 622 may perform clock phase adjustments based on feedback from the LCLK2. In another embodiment, the UCIe PHY layer of each UCIe interface module 624 may provide the RXSSCLK to the auxiliary clock module 680.

In the present embodiment, when the PHU 678 is used (e.g., when the chiplet 620 is in the PHU mode), an AECG PLL module 682 generates a PHU mode logic clock (LCLK), and provides the LCLK to a PHY PLL module 684 coupled to the UCIe interface modules 624. The PHY PLL module 684 generates a UCIe PHY clock from the LCLK and distributes the UCIe PHY clock to all four of the UCIe interface modules 624. For example, the AECG PLL module 682 may be a Birch PLL, and may have the same core as the UCIe PLL module.

In a PHU RX mode, data may be received by the GTs 622. The multi-module alignment circuitry 676 may perform alignment among two or more of the GTs 622 before passing the data to the PHU 678. The PHU 678 may include a clock domain crossing (CDC) FIFO buffer for each of the UCIe interface modules 624. The CDC FIFO buffers allow transferring data from GT clock domain(s) to the UCIe clock domain(s). The PHU 678 may use 1, 2, or 4 datapath clocks at the PHU interfaces. The PHU 678 may present 256 bits to the UCIe D2D adapter layer. In some embodiments, a PHU interface may have a frequency of 1 GHz. The PHU 678 may present 256 bits to each of the UCIe interface modules 624.

In a PHU TX mode, data may be received by the UCIe interface modules 624 (e.g., from an anchor chiplet) for transmission by the GTs 622. The PHU 678 is coupled to the UCIe interface modules 624. The CDC FIFO buffers in the PHU 678 allow transferring data from the UCIe clock domain(s) to the GT clock domain(s). Alignment may be accomplished by using data patterns added to flit format. For example, data presented by the PHU 678 may include a 255-bit payload and 1 valid bit. In another example, the data alignment pattern presented by the PHU 678 may include a 252-bit payload, 1 valid bit, and 3 alignment bits. The multi-module alignment circuitry 676 may perform alignment based on the alignment patterns before passing the data to the GTs 622.

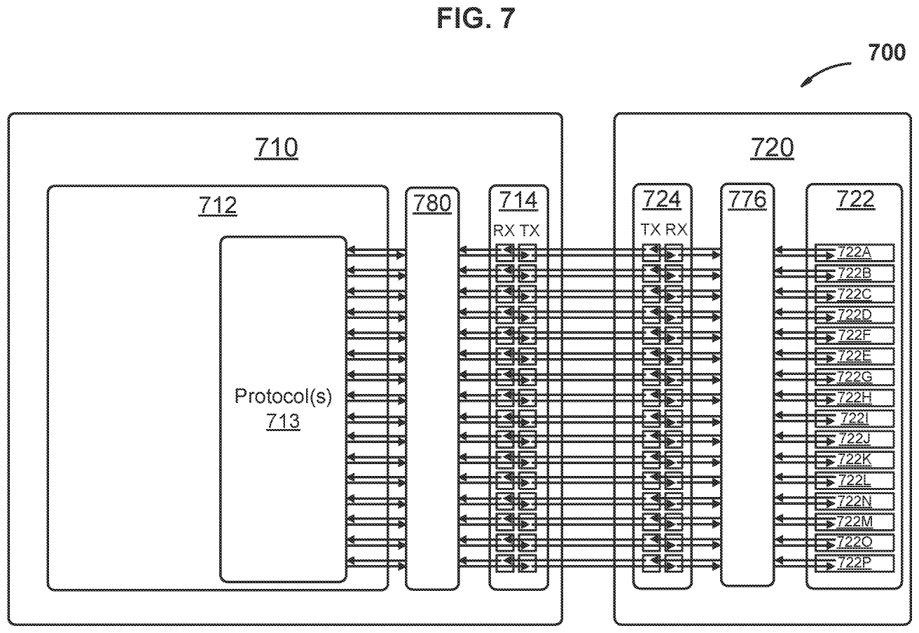

FIG. 7 is a block diagram of a multi-chiplet IC 700 including chiplet ICs (chiplets) 710 and 720, according to an example. As illustrated in FIG. 7, the chiplet 710 includes programmable logic 712 and a UCIe interface module 714. The programmable logic 712 and the UCIe interface module 714 may substantially correspond to the programmable logic 112 and the UCIe interface module 114, respectively, in FIG. 1A, the details of which are omitted for brevity. The chiplet 710 further includes alignment circuitry 780 between the programmable logic 712 and the UCIe interface module 714. The chiplet 720 includes GTs 722A through 722P (e.g., collectively referred to as “the GTs 722”) and a UCIe interface module 724. The GTs 722 and the UCIe interface module 724 may substantially correspond to the GTs 122 and the UCIe interface module 124, respectively, in FIG. 1A, the details of which are omitted for brevity. The chiplet 710 further includes alignment circuitry 776 between the GTs 722 and the UCIe interface module 724.

In the present example, the chiplet 720 includes 16 GTs 722, each having at least one TX lane and at least one RX lane. Thus, there are at least 32 data lanes between the chiplets 710 and 720. The UCIe interface module 724 includes a UCIe TX interface module and a UCIe RX interface module respectively coupled to a TX lane and an RX lane of each GT 722. In some embodiments, each of the GT lanes is capable of supporting an independent protocol and clock. For example, the GTs 722 in chiplet 720 may generate 16 independent datapaths and clocks and transmit them to the chiplet 710, and vice versa.

When the GTs 722 are in RX mode, the alignment circuitry 776 may perform lane alignment for data received from the GTs 722 before providing the aligned data to the UCIe (TX) interface module 724. The UCIe (TX) interface modules 724 on the chiplet 720 transmit data to the UCIe (RX) interface modules 714 on the chiplet 710 through 16 data lanes.

In the present example, one or more protocols 713 implemented in the programmable logic 712 support multi-lane interfaces (e.g., Ethernet, PCIe, etc.) and require lane alignment before data in different lanes from the UCIe (RX) interface module 714 can be provided to the programmable logic 712. For example, the chiplets 710 and 720 may need to meet lane alignment requirements for the 800G MACs and PCIe Gen6 controller. In another example, lane alignment is required in protocols (e.g., HSSIO protocols) implemented in programmable logic for testing and measurement purposes or for protocol customization purposes.

In the present example, data in different lanes from the UCIe (RX) interface module 714 is provided to the alignment circuitry 780, where lane alignment is implemented, for example, through low-skew REFCLK distribution and SERDES bitslip capabilities. In the present example, the alignment circuitry 780 is immediately adjacent to the UCIe interface module 714. In another example, the alignment circuitry 780 may be in the UCIe interface module 714.

When the GTs 722 are in TX mode, the alignment circuitry 780 may perform lane alignment for data received from the protocols 713 before providing the aligned data to the UCIe (TX) interface module 714. The UCIe (TX) interface modules 714 on the chiplet 710 transmit data to the UCIe (RX) interface modules 724 on the chiplet 720 through 16 data lanes. The data in different lanes from the UCIe (RX) interface module 724 is transmitted to the alignment circuitry 776 before the aligned data is provided to the GTs 722.

The alignment circuitry 776 and 780 allow data from the UCIe interface module 714 to meet lane alignment requirements of certain specialized transceiver protocols (e.g., Ethernet, PCIe, etc.).

According to an example embodiment, transceiver-generated clocks (e.g., the TX clock and RX clock) are used as the UCIe PHY clocks, instead of using the UCIe modules' own clocks for inter-chiplet data transfer. Using the transceiver-generated clocks in this fashion allows synchronous data transfer between the two chiplets (e.g., between the transceiver circuitry on the first chiplet and the transceiver protocol implemented in the programmable logic on the second chiplet). To transmit the TX and RX clocks between the two chiplets, one or more auxiliary clock transmission wires are added to connect the two chiplets. In addition, at least one TX clock pin and at least one RX clock pin are reserved in or added to the standard UCIe pin connection pattern for directly transmitting and receiving the TX and RX clocks.

According to another example embodiment, a datapath bypassing the UCIe protocol layer and the UCIe D2D adapter layer is used to allow the transceiver datapath to connect to the UCIe PHY layer directly. Bypassing the UCIe protocol layer and at least a portion of the UCIe D2D adapter layer of the UCIe interface module reduces latency in data transfer as compared data transfer through a standard UCIe module, which employs asynchronous FIFOs and adapter logic, both of which add latency to data transfer.

According to yet another example embodiment, a layer of alignment circuitry is added between the UCIe interface modules and the transceiver datapath lanes to allow flexible multi-module alignment. In one example, a data wire is allocated in each UCIe module (e.g., in the UCIe PHY layer) as an alignment marker along with logic on the receive side that detects the marker and delays the faster modules to align with the slower modules. In another example, when there are no spare data wires that can be used as an alignment marker within a module, an additional signal is added in the transceiver datapath bus to be used to as an alignment marker to perform alignment at the datapath level.

According to yet another example embodiment, a layer of alignment circuitry is added between the UCIe interface modules and the transceiver protocols implemented in the programmable logic to meet lane alignment requirements for certain protocols.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system, comprising:
a first chiplet comprising a first transceiver and a first chiplet-to-chiplet (C2C) interface module; and
a second chiplet comprising a second C2C interface module,
wherein the first transceiver is configured to generate a clock, and
wherein the clock is transmitted from the first C2C interface module to the second C2C interface module, via a clock transmission wire, for data transfer between the first chiplet and the second chiplet.

2. The system of claim 1, wherein:
the second chiplet further comprises programmable logic circuitry, and
the clock is used by a transceiver protocol implemented in the programmable logic circuitry for the data transfer between the first chiplet and the second chiplet.

3. The system of claim 1, wherein:
the clock is a transmit (TX) clock generated by the first transceiver when the first transceiver is in a TX mode; and
the TX clock is transmitted back from the second C2C interface module of the second chiplet to the first C2C interface module of the first chiplet through another clock transmission wire.

4. The system of claim 1, wherein the second chiplet further comprises programmable logic circuitry configured to transmit data in a datapath to a physical (PHY) layer of the second C2C interface module, the datapath bypassing a C2C protocol layer and at least a portion of a die-to-die (D2D) adapter layer of the second C2C interface module.

5. The system of claim 4, wherein a PHY layer of the first C2C interface module is configured to receive the data in the datapath from the PHY layer of the second C2C interface module, and to transmit the data to the first transceiver, the datapath bypassing a C2C protocol layer and at least a portion of a D2D adapter layer of the first C2C interface module.

6. The system of claim 1, wherein:
the clock is a receive (RX) clock generated by the first transceiver when the first transceiver is in an RX mode; and
a physical (PHY) layer of the first C2C interface module is configured to receive data in a datapath from the first transceiver, the datapath bypassing a C2C protocol layer and at least a portion of a die-to-die (D2D) adapter layer of the first C2C interface module.

7. The system of claim 6, wherein:
the second chiplet further comprises programmable logic circuitry; and
a PHY layer of the second C2C interface module is configured to receive the data in the datapath from the PHY layer of the first C2C interface module, and to transmit the data to the programmable logic circuitry, the datapath bypassing a C2C protocol layer and at least a portion of a D2D adapter layer of the second C2C interface module.

8. The system of claim 1, wherein:
the first chiplet further comprises a second transceiver and alignment circuitry; and
the alignment circuitry is configured to align data from the first transceiver and the second transceiver before transmitting the data to the first C2C interface module.

9. The system of claim 1, wherein:
the first chiplet further comprises a second transceiver;
the second chiplet further comprises programmable logic circuitry and alignment circuitry; and
the alignment circuitry is configured to align data from the first and second transceivers before transmitting the data to the programmable logic circuitry.

10. A method performed by a system comprising a first chiplet and a second chiplet, the method comprising:
generating a clock by a first transceiver on the first chiplet;
transmitting the clock from a first chiplet-to-chiplet (C2C) interface module on the first chiplet to a second C2C interface module on the second chiplet; and
using the clock by the second chiplet for data transfer between the first chiplet and the second chiplet.

11. The method of claim 10, further comprising:
transmitting the clock back from the second C2C interface module of the second chiplet to the first C2C interface module of the first chiplet, when the first transceiver is in a transmit (TX) mode; and
wherein the clock is a TX clock generated by the first transceiver when the first transceiver is in the TX mode.

12. The method of claim 11, further comprising:
transmitting, by programmable logic circuitry on the second chiplet, data in a datapath to a physical (PHY) layer of the second C2C interface module, the datapath bypassing a C2C protocol layer and at least a portion of a die-to-die (D2D) adapter layer of the second C2C interface module.

13. The method of claim 12, further comprising:
receiving, by a PHY layer of the first C2C interface module, the data in the datapath from the PHY layer of the second C2C interface module; and
transmitting, by the PHY layer of the first C2C interface module, the data in the datapath to the first transceiver, the datapath bypassing a C2C protocol layer and at least a portion of a D2D adapter layer of the first C2C interface module.

14. The method of claim 10, further comprising:
receiving, by a physical (PHY) layer of the first C2C interface module, data in a datapath from the first transceiver when the first transceiver is in a receive (RX) mode, the datapath bypassing a C2C protocol layer and at least a portion of a die-to-die (D2D) adapter layer of the first C2C interface module,
wherein the clock is an RX clock generated by the first transceiver when the first transceiver is in the RX mode.

15. The method of claim 14, further comprising:
receiving, by a PHY layer of the second C2C interface module, the data in the datapath from the PHY layer of the first C2C interface module; and
transmitting, by the PHY layer of the second C2C interface module, the data in the datapath to programmable logic circuitry on the second chiplet, the datapath bypassing a C2C protocol layer and at least a portion of a D2D adapter layer of the second C2C interface module.

16. The method of claim 10, further comprising:
aligning data from the first transceiver and a second transceiver of the first chiplet before transmitting the data to the first C2C interface module.

17. The method of claim 10, further comprising:
aligning data from the first transceiver and a second transceiver of the first chiplet before transmitting the data to programmable logic circuitry on the second chiplet.

18. A chiplet, comprising:
a transceiver; and
a chiplet-to-chiplet (C2C) interface module, wherein the transceiver is configured to transmit a transceiver-generated clock to another chiplet through the C2C interface module for data transfer.

19. The chiplet of claim 18, wherein:
the C2C interface module comprises a physical (PHY) layer, a die-to-die (D2D) adapter layer, and a C2C protocol layer; and
the transceiver is configured to transmit or receive data in a datapath between the transceiver and the PHY layer of the C2C interface module, the datapath bypassing the C2C protocol layer and at least a portion of the D2D adapter layer.

20. The chiplet of claim 18, further comprising:
another transceiver; and
alignment circuitry, wherein the alignment circuitry is configured to align data from the transceiver and the another transceiver before transmitting the data to the C2C interface module.
